(19) United States
(12) Patent Application Publication
(10) Pub. No.: US 2015/0364735 A1
(43) Pub. Date: Dec. 17, 2015

(54) SEALED BATTERY

(71) Applicant: SANYO ELECTRIC CO., LTD., Moriguchi-shi, Osaka (JP)

(72) Inventors: Kazutoshi Kohira, Osaka (JP); Kyosuke Miyata, Osaka (JP)

(73) Assignee: SANYO ELECTRIC CO., LTD., Daito-shi, Osaka (JP)

(21) Appl. No.: 14/763,405

(22) PCT Filed: Jan. 30, 2014
(86) PCT No.: PCT/JP2014/000471

§ 371 Date: Jul. 24, 2015

(30) Foreign Application Priority Data
Jan. 31, 2013 (JP) 2013-017321

(51) Int. Cl. H01M 2/12; H01M 4/525; H01M 10/0525; H01M 2/04

(52) U.S. Cl. CPC H01M 2/1241; H01M 2/0413; H01M 4/525; H01M 10/0525; H01M 2/043; H01M 2200/20

(57) ABSTRACT

A sealed battery according to the present invention includes a bottomed cylindrical outer can having an opening, the opening and a sealing plate being crimp-sealed with an insulating gasket interposed therebetween. The sealing plate has a thin portion that serves as a starting point of deformation of the sealing plate when a battery internal pressure increases. When the battery internal pressure increases, the sealing plate is deformed so that a gap is formed between the insulating gasket and the sealing plate and gas in the outer can is vented to the outside of the outer can. The sealing plate may be formed of a single plate-shaped member.

### TECHNICAL FIELD

The present invention relates to sealed batteries, and more particularly, to a sealed battery having a gas venting function.

### BACKGROUND ART

Lithium-ion secondary batteries have a high energy density and a large capacity, and are therefore widely used as driving power supplies for mobile data terminals, such as mobile phones and notebook computers. Recently, lithium-ion secondary batteries have been expected to be used in applications where high voltage and large capacity are required, such as driving power supplies for battery-driven automobiles and home use power storage systems.

A lithium-ion secondary battery includes a flammable organic solvent, and therefore the safety of the battery needs to be ensured. Accordingly, a sealing body that seals the battery is provided with a gas venting mechanism that vents gas in the battery to the outside of the battery when the battery internal pressure increases.

A technology regarding a gas venting mechanism according to the related art will be described with reference to FIG. 9. FIG. 9 is a sectional view of a sealing body having a structure of the related art.

A sealing body of a sealed battery according to the related art includes a valve cap 21 having vent holes 21a, a PTC thermistor 22, a pair of explosion prevention valves 23 and 25 having rupture grooves 23a and 25a that rupture when the battery internal pressure increases, an insulating plate 24 that prevents peripheral portions of the pair of explosion prevention valves 23 and 25 from coming in to electrical contact with each other, and a terminal plate 26 that has vent holes 26a and that is electrically connected to a positive plate. With this technology, when the battery internal pressure increases, first, the electrical contact between the pair of explosion prevention valves 23 and 25 is disconnected, so that the current path to the valve cap 21 is interrupted. When the battery internal pressure further increases, the rupture grooves 23a and 25a formed in the explosion prevention valves 23 and 25 rupture, so that holes are formed. And then, the gas in the battery is vented to the outside of the battery through the vent holes 26a, the holes formed in the pair of explosion prevention valves 23 and 25, and the vent holes 21a.

PTLs 1 to 3 listed below describe technologies for increasing the safety of the battery.

### CITATION LIST

### Patent Literature

PTL 1: Japanese Published Unexamined Patent Application No. 2010-287567

PTL 2: Japanese Published Unexamined Patent Application No. 2004-335287

PTL 3: Japanese Published Unexamined Patent Application No. 9-120811

PTL 1 discloses a technology regarding a battery interconnection system in which a vent, defined by scoring on a battery terminal, ruptures when the battery internal pressure exceeds a predefined battery operating range, causing an interruptible electrical connector to break and disrupt electrical continuity between a connector plate and the battery terminal. It is described that, with this technology, a system for integrating the venting feature of a battery with a device for simultaneously disconnecting the cell from the battery pack, thereby isolating the cell, is provided.

PTL 2 discloses a technology in which a sealing plate has an annular groove that is divided into segments by connecting portions, and in which the connecting portions are provided at least at two locations. It is described that, with this technology, a non-aqueous secondary battery in which a groove reliably ruptures in response to an abnormal increase in the internal pressure of the battery but does not unexpectedly rupture in response to a small impact is provided.

PTL 3 discloses a safety valve including a first safety valve and a second safety valve. The first safety valve is self-restorable and capable of opening and closing repeatedly. The second safety valve is non-self-restorable and includes a slit formed in an annular shape such that a hinge portion is left uncut, and a thermoplastic resin that airtightly covers the slit. With this safety valve, the second safety valve has a valve opening pressure higher than that of the first safety valve and lower than the pressure at which the sealing of the battery casing breaks, and the second safety valve opens when the thermoplastic resin breaks and the portion surrounded by the slit is bent at the hinge portion. It is described that, with this technology, the battery can be used even after the battery internal pressure has increased owing to the self-restorable first safety valve, and the battery casing can be effectively prevented from rupturing owing to the non-self-restorable second safety valve.

### SUMMARY OF INVENTION

### Technical Problem

In recent years, with further increase in energy density of the battery, the possibility that the battery temperature and battery internal pressure will rapidly increase in case of an abnormality has increased. Therefore, there is a risk that the gas venting performance will not be enough to deal with the rapid increase in pressure even when the above-described sealing bodies are provided. In addition, an increase in battery temperature causes a reduction in the strength of an outer can. As a result, a crack may be formed in the side wall of the outer can. If the gas or electrolyte leaks through the crack, the leakage may cause abnormalities in the surrounding components.

Driving power supplies for battery-driven automobiles, home use power storage systems, etc., generally include a battery assembly in which a plurality of unit batteries are connected in series and/or parallel. If a crack is formed in the side wall of the outer can of one of the unit batteries included in the battery assembly and leakage of the gas or electrolyte occurs, there is a higher risk that, for example, the unit batteries disposed around the unit battery with the crack will burn. For these reasons, it has become necessary to prevent cracking of the side wall of the outer can. However, these problems are not taken into account in the above-described technologies.

The present invention has been made to solve the above-described problems, and an object of the present invention is to provide a sealed battery from which gas can be vented without causing a side wall of an outer can to crack.

### Solution to Problem

To achieve the above-described object, according to the present invention, a sealed battery includes a bottomed cylindrical outer can having an opening, the opening and a sealing plate being crimp-sealed with an insulating gasket interposed therebetween. The sealing plate has a thin portion that serves as a starting point of deformation of the sealing plate when a battery internal pressure increases. When the battery internal pressure increases, the sealing plate is deformed so that a gap is formed between the insulating gasket and the sealing plate, and gas in the outer can is vented to the outside of the outer can.

The effects of the above-described structure will be described with reference to FIGS. 1 and 2. FIG. 1 is a sectional view of a sealed battery according to the present invention, and FIG. 2 is a diagram illustrating the manner in which a sealing portion of the sealed battery according to the present invention is deformed as a result of an increase in the internal pressure.

As illustrated in FIGS. 1 and 2, a sealing plate 10 of a sealed battery according to the present invention includes a thin portion 10a having a thickness smaller than that of other portions so that the strength thereof is reduced. Therefore, when the battery internal pressure increases, deformation of the sealing plate 10 starts at the thin portion 10a (see FIGS. 2(a) and 2(b)). As the deformation of the sealing plate 10 progresses, the contact force between an insulating gasket 11 and the sealing plate 10 decreases, and a gap that allows gas to be vented therethrough is formed between the sealing plate 10 and the insulating gasket 11 (see FIGS. 2(c) and 2(d)). Thus, a large opening is immediately formed in the battery, and therefore sufficient gas venting performance can be obtained even when the gas is rapidly produced. A side wall of an outer can 5 is prevented from being damaged by the internal pressure after the opening has been formed, and the risk that the side wall of the outer can 5 will crack can be significantly reduced. Accordingly, the gas and electrolyte in the outer can 5 may be guided such that they are vented only from the sealing-plate-10 side. Therefore, components adjacent to the side wall of the outer can 10 are prevented from being adversely affected. In the case where, for example, the sealed battery according to the present invention is used as one of unit batteries in a battery assembly, even when an abnormality occurs in one of the unit batteries, the safety of the other unit batteries of the battery assembly is not reduced.

In the above-described structure, the sealing plate is formed of a single plate-shaped member. In the case where the sealing plate 10 is a single plate-shaped member, the sealing plate 10 can be more easily deformed and more quickly separated from the insulating gasket 11 when the battery internal pressure increases. In addition, the sealing plate 10 can be easily manufactured.

With regard to the single plate-shaped member, there is no particular limitation as long as it is substantially formed of a single plate. For example, the plate-shaped member may be formed of a single clad material in which a plurality of materials are stacked and integrated together. Moreover, the thickness of the plate-shaped member may be either uniform or non-uniform, and the plate-shaped member may include one, two, or more step portions 10b to increase the strength thereof. In addition, a member that provides contact with an element disposed outside the battery, for example, may be provided on a portion of the plate-shaped member.

In the above-described structure, the sealing plate may be made of aluminum or an aluminum alloy. Aluminum and aluminum alloys are light, easily deformable, and highly resistant to the electrolyte, and are therefore suitable as the material of the sealing plate.

In the above-described structure, the outer can may include a side wall having a grooved portion that projects toward a battery axis, and the thin portion may be provided in a region on the inner side of the grooved portion.

In the case where crimp sealing is performed, the outer can 5 often includes a side wall having a grooved portion 5a that projects toward the battery axis. The battery internal pressure is hardly applied to the sealing plate in a region on the outer side of the grooved portion 5a. Therefore, if the thin portion 10a is in this region, there is a risk that the effect of the present invention will be reduced. Therefore, in the case where the grooved portion 5a is formed, the thin portion 10a is preferably formed on the sealing plate in an area including the region on the inner side of the grooved portion 5a, and more preferably, only in the region on the inner side of the grooved portion 5a.

In addition, the entirety of the sealing plate 10 is preferably located below a top surface of the outer can 5. In the case where the entirety of the sealing plate 10 is located below the top surface of the outer can 5, the space efficiency can be increased. Moreover, the sealing plate 10 can be prevented from receiving a direct impact, so that unnecessary deformation of the sealing plate 10 can be suppressed.

In FIG. 1, the above-described structure is achieved by arranging a step portion 10b that projects toward the inside of the battery. However, the present invention is not limited to this structure. For example, the sealing plate 10 may have a flat structure without a step, or include a step portion that projects toward the outside of the battery. Alternatively, a plurality of step portions that project in the same direction or different directions may be provided.

The above-described structure may be such that, when the battery internal pressure further increases, the sealing plate is completely released from the outer can. With this structure, the area of the opening through which the gas is vented can be significantly increased.

In the above-described structure, the sealed battery may be a lithium-ion secondary battery including a positive plate, and the positive plate may include a lithium-nickel composite oxide as a positive electrode active material, the lithium-nickel composite oxide being expressed by a general formula LiₓNi_{y}M_{1-y}O₂ (0.95≦x≦1.10, M is at least one of Co, Mn, Cr, Fe, Mg, Ti, and Al, and 0.6≦y≦0.95). The sealed battery may have a volume energy density of 500 Wh/L or more.

The lithium-nickel composite oxide has a larger capacity and higher energy density and is less expensive compared to a lithium-cobalt composite oxide (LiCoO₂) that is commonly used as the positive electrode active material of a lithium-ion secondary battery. Therefore, a battery having a volume energy density as high as 500 Wh/L or more can be produced at a low cost. In the case where the lithium-nickel composite oxide is used, there is a problem that when an abnormality occurs in the battery, a larger amount of gas is generated than in the case where the lithium-cobalt composite oxide is used. However, when the structure of the present invention is employed, even when the gas is rapidly generated as described above, the risk that the side wall of the outer can will crack can be reduced. The weight of the lithium-nickel composite oxide is preferably 50 wt % or more of the total weight of the positive electrode active material, more preferably, 80 wt % or more of the total weight, and most preferably, 100 wt % of the total weight.

As illustrated in FIGS. 3 to 5, the number of thin portions 10a may be one, two, or more. There is no particular limitation regarding the shape of the thin portions in plan view, and the thin portions may have the shape of a line, such as a straight line or a curved line, a polygonal shape, a circular shape, an irregular shape, or any combination thereof in plan view. In the case where a plurality of thin portions are provided, the thin portions may be arranged regularly (formed in the same size and arranged with constant intervals), or randomly such that the thin portions have different lengths and intervals therebetween. Also, the thin portions may be disposed so as to partially overlap one another.

For example, as illustrated in FIG. 3, one or more thin portions 10a having the shape of a straight line may be provided. In this case, the straight line may be a line that extends along a diameter of the sealing plate 10, as illustrated in FIG. 3(a), or a line that does not extend along a diameter of the sealing plate 10, as illustrated in FIG. 3(b). In the case where a plurality of thin portions having the shape of a straight line are provided, the thin portions may be arranged on the sealing plate 10 evenly (at constant intervals) as illustrated in FIG. 3(c), or unevenly (randomly) as illustrated in FIG. 3(d).

Alternatively, as illustrated in FIG. 4, one or more thin portions 10a having the shape of a curved line may be provided. In this case, the curved line may be a circle (see FIG. 4(a)) or an arc (see FIG. 4(b)) that is concentric with the outer peripheral line of the sealing plate 10, or a line that is not concentric with the outer peripheral line of the sealing plate 10 (see FIGS. 4(c) and 4(d)).

As illustrated in FIG. 5, each thin portion 10a may have a planar shape. There is no particular limitation regarding the planar shape, and the planar shape may be a polygonal shape (see FIG. 5(a)), a circular shape, an elliptical shape, a fan shape, or any other irregular shape (see FIG. 5(b)). As illustrated in FIGS. 5(c) and 5(d), thin portions having a linear line, a curved line, or a planar shape may be provided in combination. The thin portions 10a may be arranged such that they partially overlap (see FIG. 5(c)), or such that they do not overlap (see FIG. 5(d)).

There is no particular limitation regarding the cross-sectional shape of the thin portions. For example, thin portions having a linear shape may be formed by forming a recess having a V-shaped (triangular), rectangular, U-shaped, or semicircular cross section, and the depth of the recess may be either uniform or non-uniform. Also, thin portions having a planar shape may have a flat surface that is parallel to a surface of the sealing plate, or an irregular surface with projections and recesses that are arranged regularly or irregularly. To prevent rupture of the thin portion, preferably, the recess is formed so as to have obtuse or rounded corners. In addition, preferably, the thin portions are formed as a recess in a surface that faces the inside of the battery, and the remaining thickness thereof is set to such a thickness that rupture does not easily occur.

The thin portions 10a may be formed by forming a recess in a surface of the sealing plate 10 that faces the inside of the battery, as illustrated in FIGS. 3 to 5 and 7(b), or by forming a recess in a surface of the sealing plate 10 that faces the outside of the battery, as illustrated in FIGS. 6(a), 6(b), and 7(a). Alternatively, as illustrated in FIGS. 6(c), 6(d), 7(c), and 7(d), the thin portions 10a may be formed by forming recesses in both surfaces of the sealing plate 10. In FIG. 6, the thin portions 10a formed by forming a recess in the surface that faces the outside of the battery are shown by the dashed lines. In the case where recesses are formed in both surfaces of the sealing plate 10, the recesses in both surfaces may be arranged such that they coincide with each other in plan view of the sealing plate 10 (see FIG. 7(d)), such that they do not overlap each other in plan view of the sealing plate 10 (see FIGS. 6(c) and 7(c)), or such that they partially overlap each other in plan view of the sealing plate 10 (see FIG. 6(d)).

There is no particular limitation regarding the arrangement of each thin portion 10a. However, a part that is crimp-sealed with the insulating gasket 11 is not deformed when the internal pressure increases. Therefore, when a thin portion is provided on this part, the thin portion does not serve as the thin portion according to the present invention that serves as a starting point of deformation of the sealing plate when the battery internal pressure increases. Namely, it is necessary that at least a part of the thin portion 10a be provided on a part of the sealing plate that is not crimp-sealed with the insulating gasket 11. When the thin portion is provided on the crimp-sealed part, there is a risk that the sealing reliability will be reduced. Therefore, it is preferable that no part of the thin portion be provided on the crimp-sealed part of the sealing plate 10. In the case where the sealing plate 10 has the step portion 10b, at least a part of the thin portion 10a is preferably provided in a region on the outer side of the step portion 10b.

There is no particular limitation regarding the method for forming the thin portion. However, press working is preferably employed since the thin portion can be readily formed in such a case.

The sealing plate preferably functions as an external terminal of one of positive and negative electrodes of the battery. In such a case, the structure of the battery can be simplified. The outer can preferably functions as an external terminal of the other one of the positive and negative electrodes.

### Advantageous Effects of Invention

According to the above-described present invention, a sealed battery with which gas is vented only from the sealing-plate side can be provided. With this sealed battery, components arranged adjacent to the side wall of the outer can are not adversely affected. For example, in the case where the sealed battery is applied to a battery assembly, the safety of the other batteries is not reduced.

### BRIEF DESCRIPTION OF DRAWINGS

FIG. 1 is a sectional view of a sealed battery according to the present invention.

FIG. 2 shows enlarged partial sectional views illustrating the manner in which a sealing portion of the sealed battery according to the present invention is deformed as a result of an increase in the internal pressure.

FIG. 3 shows bottom views illustrating examples of arrangements of thin portions on a sealing plate.

FIG. 4 shows bottom views illustrating modifications of arrangements of thin portions on the sealing plate.

FIG. 5 shows bottom views illustrating additional modifications of arrangements of thin portions on the sealing plate.

FIG. 6 shows see-through bottom views illustrating arrangements of thin portions in the case where the thin portions are provided at least on a surface of the sealing plate that faces the outside of the battery.

FIG. 7 shows sectional views illustrating modifications of arrangements of thin portions on the sealing plate.

FIG. 8 shows bottom views illustrating arrangements of thin portions on the sealing plate according to examples, wherein FIG. 8(a) shows Examples 1 to 3, FIG. 8(b) shows Examples 4 to 6, FIG. 8(c) shows Examples 7 to 9, FIG. 8(d) shows Examples 10 to 12, and FIG. 8(e) shows Examples 13 to 15.

FIG. 9 is a sectional view of a sealing body according to the related art.

### DESCRIPTION OF EMBODIMENTS

### First Embodiment

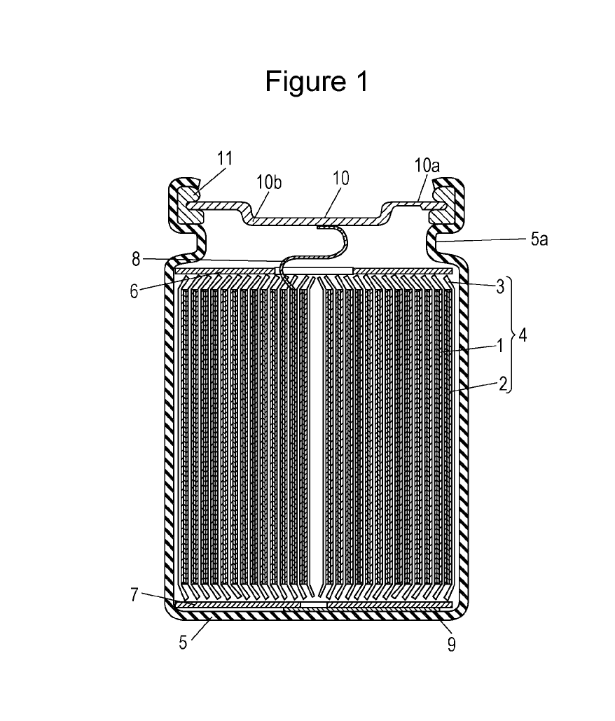

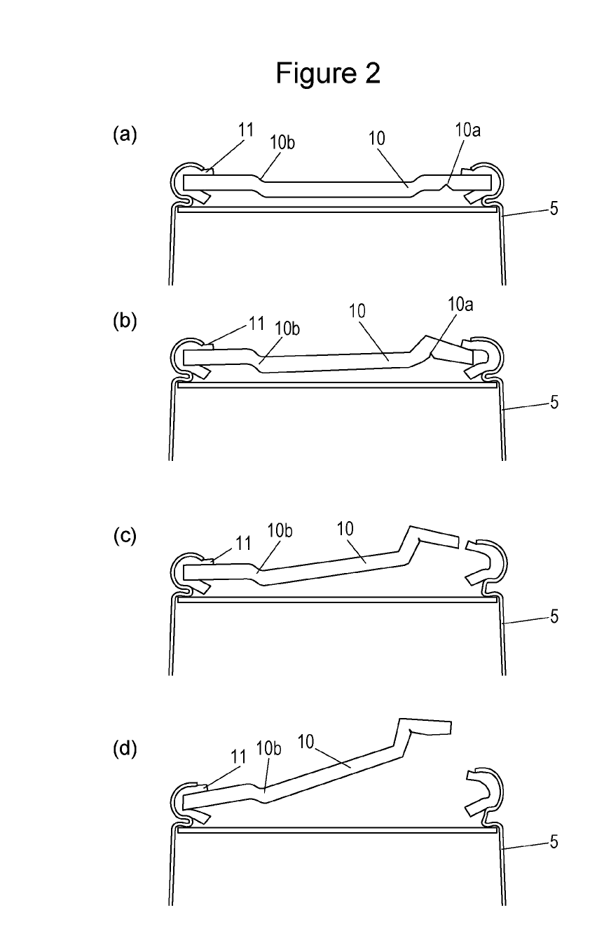

An embodiment of the present invention will be described in detail with reference to the drawings by way of an example in which the present invention is applied to a lithium-ion secondary battery. FIG. 1 is a sectional view of a sealed battery according to the present invention, and FIG. 2 shows enlarged partial sectional views illustrating the manner in which a sealing portion of the sealed battery according to the present invention is deformed as a result of an increase in the internal pressure.

As illustrated in FIG. 1, a non-aqueous electrolyte secondary battery according to the present embodiment includes a wound electrode group 4 including a positive plate 1 and a negative plate 2 that are spirally wound with a separator 3 interposed therebetween. The wound electrode group 4 is provided with insulating plates 6 and 7 that are respectively arranged at the top and bottom thereof, and is contained in a bottomed cylindrical metal outer can 5. A non-aqueous electrolyte (not shown) is poured into the outer can 5, and the opening of the outer can 5 and a sealing plate 10 are crimp-sealed with a gasket 11 interposed therebetween. The negative plate 2 has a lead 9 that is welded to an inner bottom portion of the outer can 5, and the positive plate 1 has a lead 8 that is welded to the bottom surface of the sealing plate 10. Thus, the outer can 5 serves as an external terminal of a negative electrode, and the sealing plate 10 serves as an external terminal of a positive electrode. A peripheral portion of the upper insulating plate 6 is retained by a grooved portion 5a formed on a side wall of the outer can 5, thereby securing the wound electrode group 4 from the top.

As illustrated in FIGS. 1 and 2, the sealing plate 10 includes a thin portion 10a having a thickness smaller than that of other portions so that the strength thereof is reduced. Therefore, when the battery internal pressure increases, deformation of the sealing plate 10 starts at the thin portion 10a (see FIGS. 2(a) and 2(b)). As the deformation of the sealing plate 10 progresses, the crimp seal between the insulating gasket 11 and the sealing plate 10 weakens, and a gap that allows gas to be vented therethrough is formed between the sealing plate 10 and the insulating gasket 11 (see FIGS. 2(c) and 2(d)). When the battery internal pressure further increases, the sealing plate 10 is released from the outer can 5. Thus, a large opening is immediately formed in the battery, and therefore sufficient gas venting performance can be obtained even when the gas is rapidly produced. The side wall of the outer can 5 is prevented from being damaged by the internal pressure after the opening has been formed, and the risk that the side wall of the outer can 5 will crack can be reduced. Accordingly, the gas and electrolyte in the outer can may be guided such that they are vented only from the sealing-plate side. Therefore, components adjacent to the side wall of the outer can are prevented from being adversely affected. In the case where, for example, the sealed battery according to the present invention is used as one of unit batteries in a battery assembly, even when an abnormality occurs in one of the unit batteries, the safety of the other batteries of the battery assembly is not reduced.

The sealing plate 10 is preferably formed of a single plate-shaped member made of aluminum or an aluminum alloy. When the sealing plate is formed of a single plate-shaped member, the sealing plate 10 can be easily deformed in response to an increase in the battery internal pressure, and the sealing plate 10 can be easily manufactured. In addition, aluminum and aluminum alloys are light, easily deformable, and highly resistant to the electrolyte, and are therefore suitable as the material of the sealing plate 10. Other components may be attached to the sealing plate 10 as long as the function of the present invention is not adversely affected.

The grooved portion 5a that projects toward the battery axis is formed on the side wall of the outer can 5. The insulating gasket 11 is located above the grooved portion 5a and secures the sealing plate 10. The thin portion 10a of the sealing plate 10 is provided in a region on the inner side of the grooved portion 5a. This is because the deformation-promoting effect is small when the thin portion 10a is provided in a region on the outer side of the grooved portion 5a.

In addition, the entirety of the sealing plate 10 is preferably located below a top surface of the outer can 5. In the case where the entirety of the sealing plate 10 is located below the top surface of the outer can 5, the space efficiency can be increased. Moreover, the sealing plate 10 can be prevented from receiving a direct impact, so that unnecessary deformation of the sealing plate 10 can be suppressed. The sealing plate 10 may have a flat structure without a step, or include a step portion 10b as illustrated in FIG. 1. In the case where the step portion 10b is provided, the step portion 10b may project toward the inside of the battery, as illustrated in FIG. 1, or toward the outside of the battery. Alternatively, a plurality of step portions that project in the same direction or different directions may be formed. When the step portion 10b is formed, the strength of the sealing plate 10 can be increased.

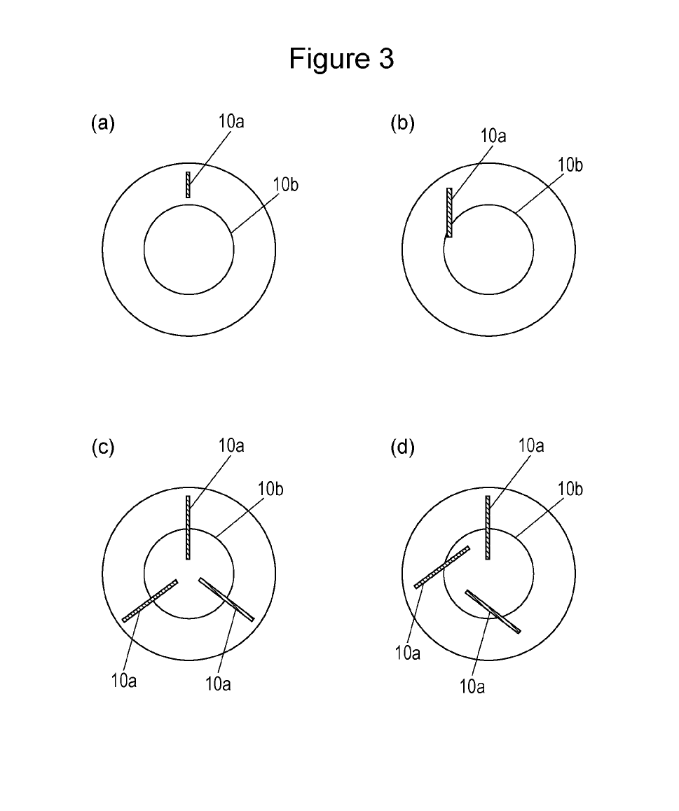

As illustrated in FIGS. 3 to 5, the number of thin portions may be one, two, or more. There is no particular limitation regarding the shape of the thin portions in plan view, and the thin portions may have the shape of a line, such as a straight line or a curved line, a polygonal shape, a circular shape, an irregular shape, or any combination thereof in plan view. In the case where a plurality of thin portions are provided, the thin portions may be arranged regularly (formed in the same size and arranged with constant intervals), or randomly such that the thin portions have different lengths and intervals therebetween. Also, the thin portions may be disposed so as to partially overlap one another.

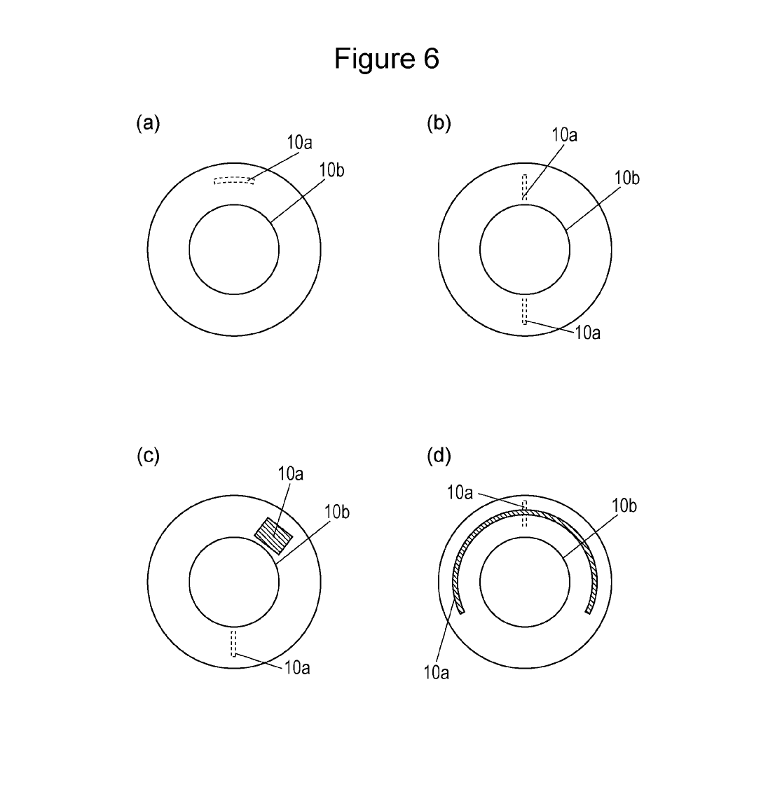

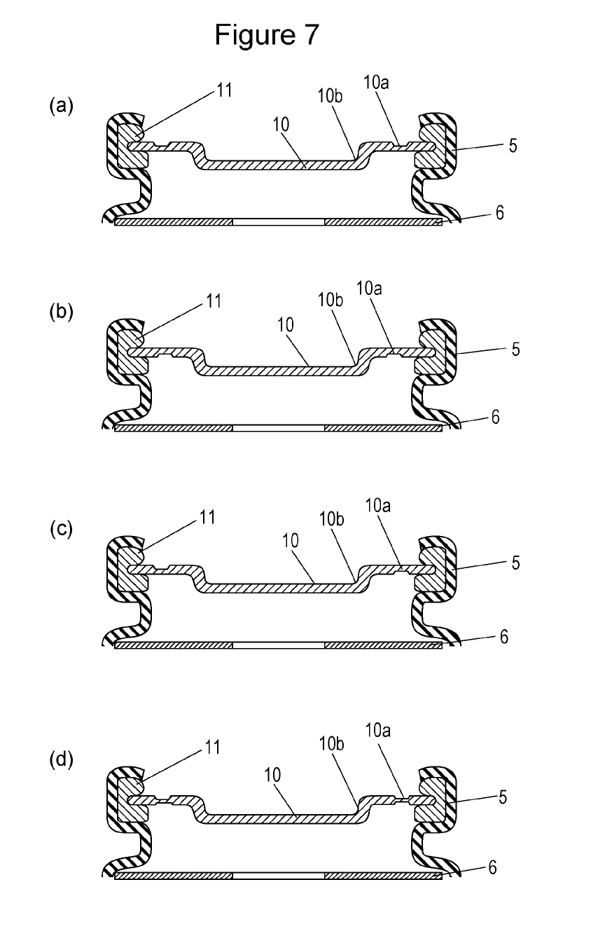

FIGS. 3 to 5 show bottom views illustrating examples of arrangements of thin portions on the sealing plate. FIG. 6 shows see-through bottom views illustrating arrangements of thin portions in the case where the thin portions are provided at least on a surface of the sealing plate that faces the inside of the battery. FIG. 7 shows sectional views illustrating modifications of arrangements of thin portions on the sealing plate. For example, as illustrated in FIG. 3, one or more thin portions 10a having the shape of a straight line may be provided. The straight line may be a line that extends along a diameter of the sealing plate 10, as illustrated in FIG. 3(a), or a line that does not extend along a diameter of the sealing plate 10, as illustrated in FIG. 3(b). In the case where a plurality of thin portions having the shape of a straight line are provided, the thin portions may be arranged on the sealing plate 10 evenly as illustrated in FIG. 3(c), or unevenly as illustrated in FIG. 3(d).

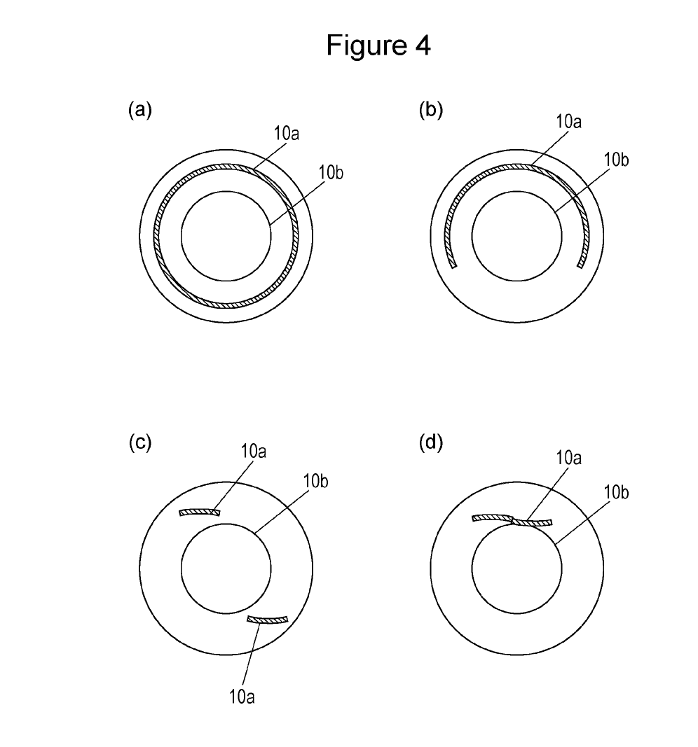

Alternatively, as illustrated in FIG. 4, for example, one or more thin portions 10a having the shape of a curved line may be provided. In this case, the curved line may be a circle or an arc that is concentric with the outer peripheral line of the sealing plate 10, as illustrated in FIGS. 4(a) and 4(b), or a randomly curved line that is not concentric with the outer peripheral line of the sealing plate 10, as illustrated in FIGS. 4(c) and 4(d).

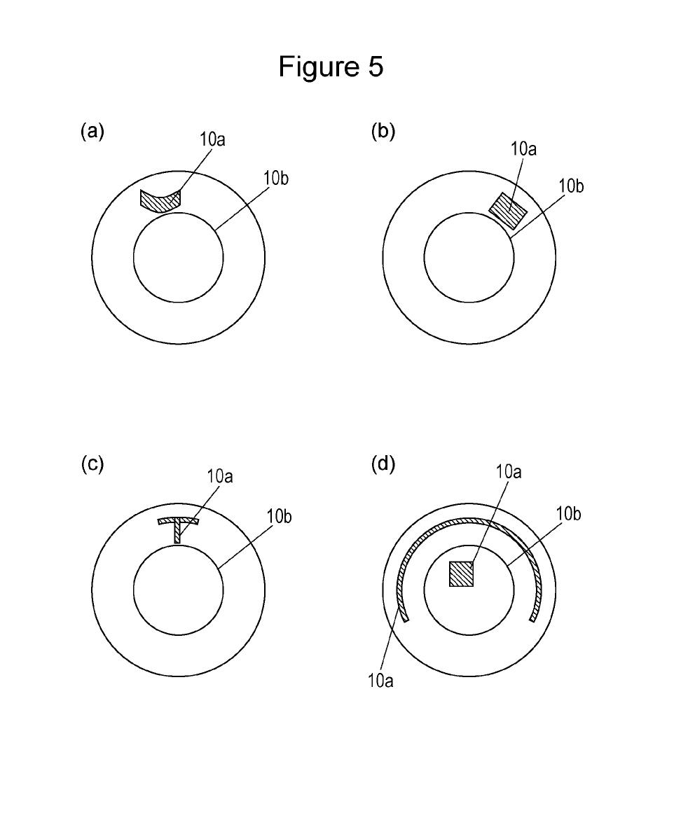

As illustrated in FIG. 5, for example, each thin portion 10a may have a planar shape. There is no particular limitation regarding the planar shape, and the planar shape may be a polygonal shape (see FIG. 5(a)), a circular shape, an elliptical shape, a fan shape, or any other irregular shape (see FIG. 5(b)). As illustrated in FIGS. 5(c) and 5(d), thin portions having a linear line, a curved line, or a planar shape may be provided in combination. The thin portions 10a may be arranged such that they overlap (see FIG. 5(c)), or such that they do not overlap (see FIG. 5(d)).

The thin portions 10a may be formed by forming a recess in a surface of the sealing plate 10 that faces the inside of the battery, as illustrated in FIGS. 3 to 5 and 7(b), or by forming a recess in a surface of the sealing plate 10 that faces the outside of the battery, as illustrated in FIGS. 6(a), 6(b), and 7(a). Alternatively, as illustrated in FIGS. 6(c), 6(d), 7(c), and 7(d), the thin portions 10a may be formed by forming recesses in both surfaces of the sealing plate 10. In the case where recesses are formed in both surfaces of the sealing plate 10, the recesses in both surfaces may be arranged such that they coincide with each other in plan view of the sealing plate 10 (see FIG. 7(d)), such that they do not overlap each other in plan view of the sealing plate 10 (see FIGS. 6(c) and 7(c)), or such that they partially overlap each other in plan view of the sealing plate 10 (see FIG. 6(d)).

There is no particular limitation regarding the arrangement of each thin portion 10a. However, in the case where the sealing plate 10 has the step portion 10b, at least a part of the thin portion 10a is preferably provided in a region on the outer side of the step portion 10b.

There is no particular limitation regarding the cross-sectional shape of the thin portions. For example, thin portions having a linear shape may be formed by forming a recess having a V-shaped (triangular), rectangular, U-shaped, or semicircular cross section, and the depth of the recess may be either uniform or non-uniform. Also, thin portions having a planar shape may have a flat surface that is parallel to a surface of the sealing plate, or an irregular surface with projections and recesses that are arranged regularly or irregularly. To prevent rupture of the thin portions, preferably, the recess is formed so as to have obtuse or rounded corners, or is formed in a surface that faces the inside of the battery. In addition, preferably, the remaining thickness of the thin portions is set to such a thickness that rupture does not easily occur.

The present invention will be further described by way of examples.

### EXAMPLE 1

### <Preparation of Positive Electrode>

A lithium-nickel-cobalt-aluminum composite oxide (LiNi_{0.8}Co_{0.15}Al_{0.05}O₂) that serves as a positive electrode active material, acetylene black that serves as a conducting agent, and polyvinylidene fluoride (PVDF) that serves as a binder were prepared at a mass ratio of 100:2.5:1.7, and were mixed with N-methyl-2-pyrrolidone, which is an organic solvent. Thus, positive electrode active material paste was prepared.

Next, the positive electrode active material paste was applied to both surfaces of a positive electrode current collector formed of an aluminum film (15 μm thick) to a uniform thickness by using a doctor blade.

This electrode plate was dried with a drier to remove the organic solvent, so that a dry electrode plate was obtained. The dry electrode plate was rolled with a rolling press, and was cut. Then, the positive electrode lead 8 made of aluminum was attached by ultrasonic welding to a portion of the positive electrode current collector to which the positive electrode active material paste was not applied. Thus, the positive plate 1 that was 573 mm long, 57 mm wide, and 163 μm thick was produced.

### <Preparation of Negative Electrode>

Graphitizing carbon particles that serve as a negative electrode active material, polyvinylidene fluoride (PVDF) that serves as a binder, and carboxymethyl cellulose that serves as a thickener were mixed at a mass ratio of 100:0.6:1, and then were mixed with an appropriate amount of water. Thus, negative electrode active material paste was prepared.

Next, the negative electrode active material paste was applied to both surfaces of a negative electrode current collector made of a copper film (10 μm thick) to a uniform thickness by using a doctor blade.

This electrode plate was dried with a drier to remove the moisture, so that a dry electrode plate was obtained. Then, the dry electrode plate was rolled with a rolling press, and was cut. After that, the negative electrode lead 9 made of nickel was attached by ultrasonic welding to a portion of the negative electrode current collector to which the negative electrode active material paste was not applied. Thus, the negative plate 2 was produced.

### <Preparation of Electrode Group>

The above-described positive and negative electrodes and the separator 3 made of a polyethylene microporous film were wound by a winder, and a piece of insulating tape was provided at the winding end. Thus, the wound electrode group 4 was completed.

### <Preparation of Sealing Plate>

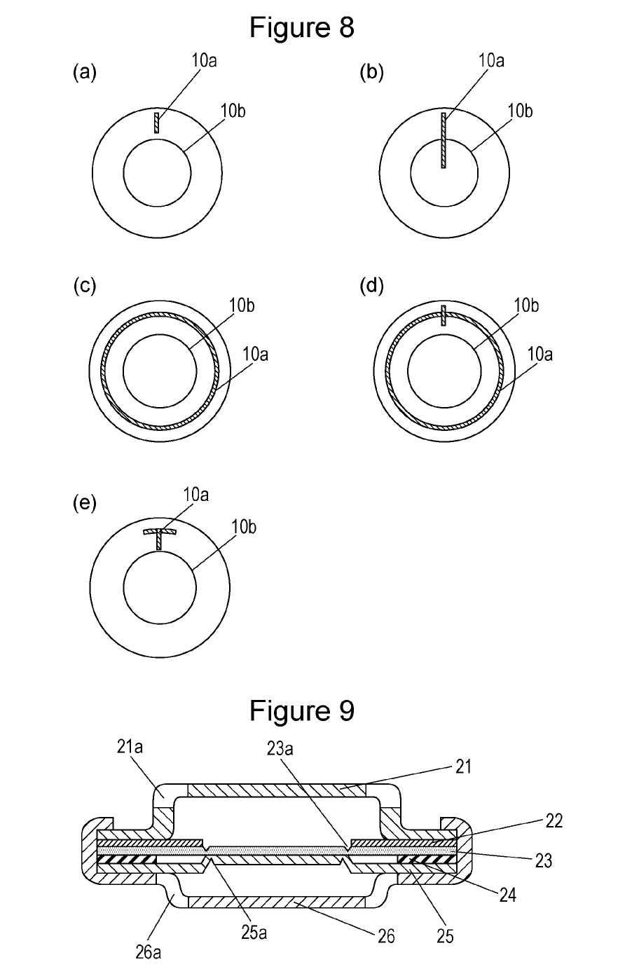

The sealing plate 10 having a diameter of 16.59 mm was produced by performing press working on a disc-shaped aluminum plate having a thickness of 0.8 mm. The sealing plate 10 included the thin portion 10a (remaining thickness 0.6 mm) formed as a recess (0.2 mm deep) in the surface of the sealing plate 10 facing the inside of the battery, and the step portion 10b projecting toward the inside of the battery. FIG. 8 shows bottom views illustrating arrangements of thin portions on the sealing body according to the examples. In the present example, the shape and arrangement of the thin portion were as illustrated in FIG. 8(a). The thin portion 10a was 1.5 mm long and 0.5 mm wide, and had a V-shaped cross section. The distance from the outer periphery of the sealing plate to the thin portion 10a was 2.0 mm.

### <Preparation of Non-aqueous Electrolyte>

A non-aqueous solvent was produced by mixing ethylene carbonate (EC), dimethyl carbonate (DMC), and ethyl methyl carbonate (EMC) at a volume ratio of 2:2:6 (at 1 atm and 25° C.), and LiPF₆ that served as an electrolyte salt was dissolved into the non-aqueous solvent at a rate of 1.0 M (mol/liter). Thus, the non-aqueous electrolyte was prepared.

### <Battery Assembly>

The insulating plates 6 and 7 made of polypropylene were arranged at the top and bottom of the electrode group 4, and the electrode group 4 was inserted into the outer can 5. Then, the negative electrode lead 9 was resistance-welded to the bottom of the cylindrical outer can 5. After that, the grooved portion 5a having a circular shape that was 1.0 mm wide and 1.5 mm deep was formed on the outer can 5, and the above-described non-aqueous electrolyte was injected into the cylindrical outer can 5. Then, the sealing plate 10 and the positive electrode lead 8 were laser-welded together. The opening of the outer can 5 was crimp-sealed with the use of the sealing plate 10 to which the gasket 11 was inserted. Thus, a sealed battery according to Example 1 having a height of 65 mm and a diameter of 18 mm was produced. The material of the cylindrical outer can was a steel plate plated with nickel, and the thickness thereof was 0.3 mm at the bottom and 0.25 mm at the side wall. The volume energy density of the battery was 600 Wh/L.

### EXAMPLES 2 TO 15

Referring to Table 1, sealed batteries according to Examples 2 to 15 were manufactured by a method similar to that in Example 1 except that the arrangement, number, and remaining thickness of thin portions were changed. In each of Examples 2 and 3, the length of the thin portion 10a and the distance from the outer periphery of the sealing body to the thin portion 10a were the same as those in Example 1. In each of Examples 2 to 15, the groove had a width of 0.5 mm and a V-shaped cross section.

In Examples 4 to 6, the thin portion 10a was 1.5 mm long and the distance thereto from the outer periphery of the sealing body was 2.0 mm.

In Examples 7 to 9, the thin portion 10a had the shape of a circle concentric with the outer periphery of the sealing body, and the distance thereto from the outer periphery of the sealing body was 2.5 mm.

In Examples 10 to 12, among the thin portions 10a, the curved thin portion 10a had the shape of a circle concentric with the outer periphery of the sealing body, and the distance thereto from the outer periphery of the sealing body was 2.5 mm. The linear thin portion 10a was 1.0 mm long and the distance thereto from the outer periphery of the sealing body was 2.0 mm. The linear thin portion 10a intersected the curved thin portion at the midpoint thereof.

In Examples 13 to 15, among the thin portions 10a, the curved thin portion 10a had the shape of an arc concentric with the outer periphery of the sealing body, and the distance thereto from the outer periphery of the sealing body was 2.5 mm. The central angle of the arc was 20°. The linear thin portion 10a was 1.0 mm long and the distance thereto from the outer periphery of the sealing body was 2.0 mm. The arc-shaped thin portion 10a intersected the outer end of the linear thin portion at the midpoint thereof.

### COMPARATIVE EXAMPLE 1

A sealed battery according to Comparative Example 1 was produced by a method similar to that in Example 1 except that the sealing body had a structure according to the related art in which the pair of explosion prevention valves 23 and 25 were provided, as illustrated in FIG. 9. The remaining thicknesses of the rupture grooves 23a and 25a in the explosion prevention valves 23 and 25 were 0.04 mm and 0.03 mm, respectively.

### [Safety Test]

Ten sealed batteries were prepared for each of the above-described Examples 1 to 15 and Comparative Example 1, and were charged to a voltage of 4.2 V with a constant current of 1500 mA at a room temperature (25° C.). Then, the batteries were heated on a hot plate set to 200° C. Then, whether or not the sealing plate or sealing body had been removed from the outer can and whether or not cracks had been formed in the side wall of the outer can were visually observed. Table 1 shows the results of the observation.

TABLE 1

| | | | Number | |
|---|---|---|---|---|
| | | Remaining | of samples | Number of |
| | Arrangement | thickness of | in which | samples in |
| | of thin | thin portions | sealing plate | which cracks |
| | portions | (mm) | was separated | were formed |
| Example 1 | FIG. 8(a) | 0.6 | 10 | 2 |
| Example 2 | FIG. 8(a) | 0.4 | 10 | 0 |
| Example 3 | FIG. 8(a) | 0.2 | 10 | 0 |
| Example 4 | FIG. 8(b) | 0.6 | 10 | 1 |
| Example 5 | FIG. 8(b) | 0.4 | 10 | 0 |
| Example 6 | FIG. 8(b) | 0.2 | 10 | 0 |
| Example 7 | FIG. 8(c) | 0.6 | 10 | 2 |
| Example 8 | FIG. 8(c) | 0.4 | 10 | 1 |
| Example 9 | FIG. 8(c) | 0.2 | 10 | 0 |
| Example 10 | FIG. 8(d) | 0.6 | 10 | 1 |
| Example 11 | FIG. 8(d) | 0.4 | 10 | 0 |
| Example 12 | FIG. 8(d) | 0.2 | 10 | 0 |
| Example 13 | FIG. 8(e) | 0.6 | 10 | 1 |
| Example 14 | FIG. 8(e) | 0.4 | 10 | 0 |
| Example 15 | FIG. 8(e) | 0.2 | 10 | 0 |
| Comparative | FIG. 9 | — | 2 | 9 |
| Example 1 | | | | |

As is clear from Table 1, in Examples 1 to 15 in which the opening was sealed by using the sealing plate 10 that was formed of a single aluminum plate and on which the thin portions 10a were formed, the number of samples in which cracks were formed in the side wall was 0 to 2. In contrast, in Comparative Example 1 in which the opening was sealed by using the sealing body formed of a plurality of members according to the related art, the number of samples in which cracks were formed in the side wall was 9. Thus, it is clear that the number of cracks formed in the side wall is significantly reduced in the batteries according to the examples.

The reason for this will now be discussed. According to the examples, when the battery internal pressure increases, deformation of the sealing plate 10 is immediately started at the thin portions 10a that have a low strength. Accordingly, the contact force between the gasket 11 and the sealing plate 10 decreases, and a gap that allows gas to be vented therethrough is formed. Eventually, the sealing plate 10 is completely removed from the outer can 5 in all of the batteries (see FIG. 2). Therefore, a large opening is immediately formed in each battery, and therefore sufficient gas venting performance can be provided even when the gas is rapidly produced. Thus, the side wall of the outer can is prevented from being damaged after the valve has been activated (sealing plate has been removed).

In contrast, in Comparative Example 1, when the battery internal pressure increases, the electrical connection between the pair of explosion prevention valves 23 and 25 is disconnected, resulting in the current interruption. And then, the rupture grooves in the explosion prevention valves 23 and 25 rupture to ensure a gas ventilation path. The gas ventilation path is smaller than that in the examples, and is not formed until the pressure reaches a higher pressure than that in the examples. Therefore, in the case where the power of the gas is strong, the risk that the side wall of the outer can 5 will be damaged is higher than that in the examples. Accordingly, in Comparative Example 1, formation of cracks in the side wall of the outer can 5 cannot be sufficiently suppressed. When the cracks are formed in the side wall of the outer can 5, the gas or electrolyte may leak through the cracks. Therefore, there is a risk that components, batteries, or the like disposed around the battery in which an abnormality has occurred will be adversely affected. Here, the rupture of the rupture grooves 23a and 25a was observed in all of the batteries according to Comparative Example 1.

It is clear from Examples 1 to 15 that the number of samples in which cracks were formed decreases as the remaining thickness of the thin portions 10a decreases. This is probably because when the remaining thickness of the thin portions 10a decreases, the sealing plate 10 can be deformed more quickly in response to an increase in the battery internal pressure, so that the gap is more quickly formed between the gasket 11 and the sealing plate 10 and the sealing plate 10 is more quickly separated.

In addition, it is clear from Examples 1 to 15 that as long as the thin portions 10a are formed on the sealing plate 10, sufficient effect can be obtained irrespective of the planar shape and arrangement (linear shape, circular shape, arc shape, or combination thereof) of the thin portions 10a.

As is clear from the above-described test results, according to the present invention, a sealed battery including a sealing plate provided with a safer gas ventilation valve can be provided without causing a deformation due to welding.

### (Additional Description)

Although examples in which the present invention is applied to non-aqueous electrolyte secondary batteries are described above, the present invention is not limited to this. For example, the present invention may also be applied to alkaline storage batteries such as nickel-hydrogen storage batteries and nickel-cadmium storage batteries.

In the case where the present invention is applied to a non-aqueous electrolyte secondary battery, components of the battery may be made of known materials. Examples of known materials will now be described.

The positive plate according to the present invention may be obtained by forming positive electrode active material layers on a foil-shaped (thin-plate-shaped) positive electrode current collector. The material of the positive electrode current collector may be, for example, aluminum, an aluminum alloy, a stainless steel, titanium, or a titanium alloy. In particular, aluminum or an aluminum alloy is preferably used since electrochemical elusion or the like does not easily occur in such a case.

The positive electrode active material may be a lithium transition metal composite oxide, for example, a composite oxide containing lithium and at least one metal selected from cobalt, manganese, nickel, chromium, iron, and vanadium. In particular, a lithium-nickel composite oxide expressed by a general formula LiₓNi_{y}M_{1-y}O_{2 (}0.95≦x≦1.10, M is at least one of Co, Mn, Cr, Fe, Mg, Ti, and Al, and 0.6≦y≦0.95) is preferably used.

The negative plate according to the present invention may be obtained by forming negative electrode active material layers on a negative electrode current collector. The material of the negative electrode current collector may be, for example, copper, a copper alloy, nickel, a nickel alloy, a stainless steel, aluminum, or an aluminum alloy. In particular, copper, a copper alloy, nickel, or a nickel alloy is preferably used since electrochemical elusion or the like does not easily occur in such a case.

The negative electrode active material may be a carbon material capable of reversibly occluding and releasing lithium ions such as natural graphite, spherical or fibrous artificial graphite, non-graphitizable carbon (hard carbon), or graphitizable carbon (soft carbon), a metal oxide material such as stannic oxide or silicon oxide, silicon, or a silicon-containing compound such as silicide.

The separator may be formed of a microporous film made of a polyolefin material, and is preferably formed of a combination of a polyolefin material and a heat resistant material. The polyolefin may be, for example, polyethylene, polypropylene, or ethylene-propylene copolymer. These resins may be used individually, or in combination of two or more thereof. The heat resistant material may be, for example, a heat resistant resin such as aramid, polyimide, or polyamide-imide, or a mixture of a heat resistant resin and an inorganic filler.

The non-aqueous electrolyte is prepared by dissolving a lithium salt into a non-aqueous solvent. The non-aqueous solvent may be, for example, a cyclic carbonate such as ethylene carbonate, propylene carbonate, or butylene carbonate, or a chain carbonate such as dimethyl carbonate, diethyl carbonate, or ethyl methyl carbonate, which may be used individually or as a mixture of two or more thereof. The lithium salt may be, for example, a highly electrophilic lithium salt, such as LiPF₆, LiBF₄, or LiClO₄, which may be used individually or as a mixture of two or more thereof. A known additive, such as vinylene carbonate, may be added to the non-aqueous electrolyte.

### INDUSTRIAL APPLICABILITY

As described above, the present invention provides a sealed battery with which gas can be vented while leakage of the gas or electrolyte through a side wall of an outer can is suppressed. In this respect, the present invention has a great industrial significance.

### REFERENCE SIGNS LIST

1 positive plate

2 negative plate

3 separator

4 wound electrode group

5 outer can

5a grooved portion

6 upper insulating plate

7 lower insulating plate

8 positive electrode lead

9 negative electrode lead

10 sealing plate

10a thin portion

10b step portion

11 insulating gasket

21 valve cap

21a vent hole

22 PTC thermistor

23 explosion prevention valve

23a rupture groove

24 insulating plate

25 explosion prevention valve

25a rupture groove

26 terminal plate

26a vent hole

1. A sealed battery comprising a bottomed cylindrical outer can having an opening, the opening and a sealing plate being crimp-sealed with an insulating gasket interposed therebetween,
wherein the sealing plate has a thin portion that serves as a starting point of deformation of the sealing plate when a battery internal pressure increases, and
wherein, when the battery internal pressure increases, the sealing plate is deformed so that a gap is formed between the insulating gasket and the sealing plate and gas in the outer can is vented to the outside of the outer can.

2. The sealed battery according to claim 1,
wherein the sealing plate is formed of a single plate-shaped member.

3. The sealed battery according to claim 1,
wherein sealing plate is made of aluminum or an aluminum alloy.

4. The sealed battery according to claim 1,
wherein the outer can includes a side wall having a grooved portion that projects toward a battery axis, and
wherein the thin portion is provided in a region on the inner side of the grooved portion.

5. The sealed battery according to claim 1,
wherein an entirety of the sealing plate is located below a top surface of the outer can.

6. The sealed battery according to claim 1,
wherein, when the battery internal pressure further increases, the sealing plate is completely released from the outer can.

7. The sealed battery according to claim 1,
wherein the sealed battery is a lithium-ion secondary battery including a positive plate,
wherein the positive plate includes a lithium-nickel composite oxide as a positive electrode active material, the lithium-nickel composite oxide being expressed by a general formula LiₓNi_{y}M_{1-y}O_{2 (}0.95≦x≦1.10, M is at least one of Co, Mn, Cr, Fe, Mg, Ti, and Al, and 0.6≦y≦0.95), and
wherein the sealed battery has a volume energy density of 500 Wh/L or more.
